(19) United States
(12) Patent Application Publication
(10) Pub. No.: US 2024/0354394 A1
(43) Pub. Date: Oct. 24, 2024

(54) SIGNATURE VERIFICATION DEVICE, SIGNATURE VERIFICATION METHOD, STORAGE MEDIUM STORING SIGNATURE VERIFICATION PROGRAM, AND ENCRYPTION PROCESSING DEVICE

(71) Applicant: DENSO CORPORATION, Kariya-city (JP)

(72) Inventors: Yasuharu SUGANO, Kariya-city (JP); Takeshi NAKAMURA, Kariya-city (JP)

(21) Appl. No.: 18/635,095

(22) Filed: Apr. 15, 2024

(30) Foreign Application Priority Data
Apr. 19, 2023 (JP) 2023-068624

(51) Int. Cl. G06F 21/44; G06F 21/57

(52) U.S. Cl. CPC G06F 21/44; G06F 21/572; G06F 2221/033

(57) ABSTRACT

A signature verification device is configured to receive a file and a signature, compare a first security strength, which is a security strength of the signature, with a second security strength, and execute processing for utilizing the file. The signature verification device is configured to execute processing for utilizing the file when the first security strength is higher than the second security strength, and not execute the processing for utilizing the file when the first security strength is lower than the second security strength.

### CROSS REFERENCE TO RELATED APPLICATION

This application is based on Japanese Patent Application No. 2023-068624 filed on Apr. 19, 2023, the disclosure of which is incorporated herein by reference.

### TECHNICAL FIELD

The present disclosure relates to a signature verification device, which is mainly mounted in an in-vehicle electronic control system, receives a file that records information from an external device, and executes processing for utilizing the file based on a security strength of a signature or encryption, an encryption processing device, a method implemented by the signature verification device or the like, and a program executable by the signature verification device or the like.

### BACKGROUND

A related art discloses a technology of collecting, from a server, compromise information indicating that an encryption key is compromised, specifying the encryption key to be updated based on encryption compromise information, and updating the encryption key.

### SUMMARY

A signature verification device is configured to receive a file and a signature, compare a first security strength, which is a security strength of the signature, with a second security strength, and execute processing for utilizing the file. The signature verification device is configured to execute processing for utilizing the file when the first security strength is higher than the second security strength, and not execute the processing for utilizing the file when the first security strength is lower than the second security strength.

### BRIEF DESCRIPTION OF DRAWINGS

Objects, features and advantages of the present disclosure will become more apparent from the following detailed description made with reference to the accompanying drawings. In the drawings:

FIG. 1 is a diagram illustrating an arrangement of a signature verification device or the like;

FIGS. 2A to 2C are diagrams each illustrating an arrangement of the signature verification device or the like and an electronic control system (an electronic control unit);

FIG. 3 is a diagram illustrating a configuration example of the electronic control system;

FIGS. 4A and 4B are diagrams illustrating a difficulty of the signature verification device in a related art;

FIG. 5 is a block diagram illustrating a configuration of a signature verification device according to first, second, and third embodiments;

FIG. 6 is a diagram illustrating a signature information table used in the signature verification device according to the first, second, and third embodiments;

FIGS. 7A to 7C are diagrams illustrating specific examples of an operation of the signature verification device according to the first embodiment;

FIG. 8 is a diagram illustrating an operation of the signature verification device according to the first embodiment;

FIG. 9 is a diagram illustrating a structure of a file used in a signature verification device according to a first modification of the first embodiment;

FIG. 10 is a diagram illustrating an operation of the signature verification device according to the second embodiment;

FIG. 11 is a diagram illustrating an operation of the signature verification device according to the third embodiment;

FIG. 12 is a block diagram illustrating a configuration of an encryption processing device according to a fourth embodiment; and

FIG. 13 is a diagram illustrating an encryption information table used in the encryption processing device according to the fourth embodiment.

### DETAILED DESCRIPTION

Various electronic control units connected via an in-vehicle network are mounted on an automobile. With recent development of autonomous driving technology, functions required for the automobile become complicated, and thus the number of electronic control units mounted on the automobile is increasing.

Software of the electronic control unit needs to be updated for a purpose of improving security performance by eliminating a vulnerability, adding a new function, and improving existing functions. An update file for updating the software can be provided from, for example, a distribution device through a communication line.

When the update file is provided from the distribution device, it is desirable to transmit the update file attached with a signature for a purpose of confirming integrity of the update file, authenticating the update file, and preventing the update file from being repudiated. Alternatively, it is desirable to encrypt a program or data included in the update file for a purpose of preventing leakage.

However, with development of research on attack methods and analytical equipment, compromise of the signature and encryption has become a difficulty.

The inventors of the present application have found the following difficulties as a result of detailed study.

A security strength of a signature or encryption is determined by a signature method or an encryption method, that is, an algorithm of the signature or encryption, and a key length, which is a length of a key used in the algorithm. When the algorithm is compromised, for example, even if the key length is extended as described in a related art, security cannot be ensured since the signature or the like can be forged using the compromised algorithm.

The present disclosure provides a signature verification device or the like capable of restricting utilization of a potentially fraudulent file, such as preventing an update of unauthorized software, even when an algorithm is compromised.

According to one aspect of the present disclosure, a signature verification device that receives, from an external device, a file that records information and a signature generated based on the information, and executes processing on the file is provided. The signature verification device comprises: a reception unit configured to receive the file and the signature; a security strength comparison unit configured to compare a first security strength, which is a security strength of the signature, with a second security strength, which is a security strength of a signature received together with a previously received file; and a file utilization processing execution unit configured to execute processing for utilizing the file. The file utilization processing execution unit is configured to execute the processing for utilizing the file when the first security strength is higher than the second security strength, and not execute the processing for utilizing the file when the first security strength is lower than the second security strength.

According to one aspect of the present disclosure, an encryption processing device that receives a file that records encrypted information from an external device, and executes processing on the file is provided. The encryption processing device comprises: a reception unit configured to receive the file; a security strength comparison unit configured to compare a first security strength, which is a security strength of encryption used to encrypt the information, with a second security strength, which is a security strength of encryption used to encrypt information included in a previously received file; and a file utilization processing execution unit configured to execute processing for utilizing the file. The file utilization processing execution unit is configured to execute the processing for utilizing the file when the first security strength is higher than the second security strength, and not execute the processing for utilizing the file when the first security strength is lower than the second security strength.

The technical fields are merely examples, and the present disclosure is not limited thereto. For example, it may be a device for purposes other than on-vehicle use. The purpose may not be to update software. For example, the purpose may be to download data.

According to the configuration of the present disclosure, since the signature verification device or the like determines whether to execute the processing for utilizing the file by comparing the security strength of the signature or encryption of the received file with the security strength of the signature or encryption of the previously received file, it is possible to implement a signature verification device capable of restricting utilization of a potentially fraudulent file, such as preventing an update of unauthorized software and data downloading, even when the algorithm is compromised.

Hereinafter, embodiments of the disclosure will be described with reference to the drawings.

When there are multiple embodiments (including modifications), the configurations disclosed in the embodiments are not limited to the embodiments, and can be combined across the embodiments. For example, the configuration disclosed in one embodiment may be combined with other embodiments. The disclosed configurations in respective multiple embodiments may be collected and combined.

### 1. Configuration as Prerequisite of Each Embodiment

### (1) Arrangement of Signature Verification Device or Encryption Processing Device

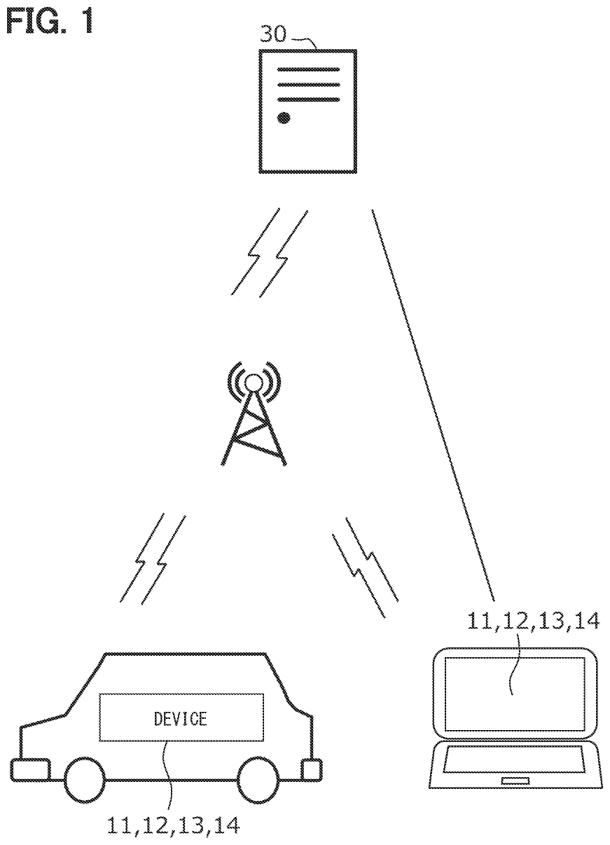

FIG. 1 is a diagram illustrating an arrangement of a “signature verification device” or an “encryption processing device” according to each embodiment. For example, as illustrated in a first case in FIG. 1, a signature verification device 11, a signature verification device 12, a signature verification device 13, and an encryption processing device 14 (hereinafter abbreviated as the signature verification device 11 or the like) are “mounted” on a vehicle that is a “moving object”. Alternatively, as illustrated in a second case in FIG. 1, the signature verification device 11 or the like may not necessarily be “mounted” on the “moving object”. Examples of a form of the signature verification device 11 or the like in the first case in FIG. 1 include an electronic control unit (ECU), but are not limited thereto. Examples of the form of the signature verification device 11 or the like in the second case in FIG. 1 include a personal computer (PC) or a smartphone, but are not limited thereto.

The “moving object” refers to a movable object, and a travel speed thereof is as desired. A case where the moving object is stopped is also included. Examples of the moving object include, but are not limited to, an automobile, a motorcycle, a bicycle, a pedestrian, a ship, an aircraft, and an object mounted thereon.

The term “mounted” includes not only a case where an object is directly fixed to the moving object but also a case where an object is moved together with the moving object although the object is not fixed to the moving object. Examples of the object include one carried by a person in the moving object, and one mounted on a load placed in the moving object.

In the first case in FIG. 1, the signature verification device 11 or the like receives a file that records information from an external device 30 mainly via wireless communication. When the vehicle is parked or accommodated in a repair shop, the file may be received via wired communication. In the second case in FIG. 1, the signature verification device 11 or the like receives a file from the external device 30 via wireless communication or wired communication.

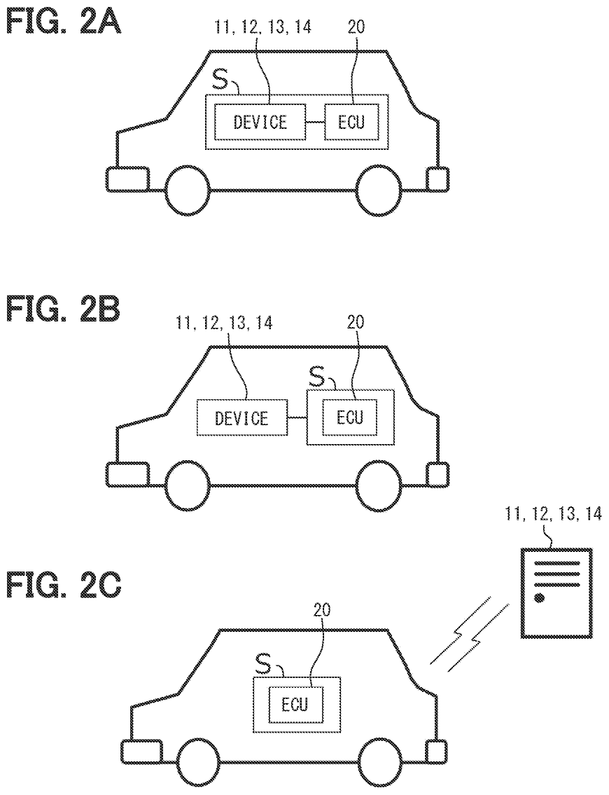

FIGS. 2A to 2C are diagrams each illustrating an arrangement of the signature verification device 11 or the like according to each embodiment and an electronic control system S. The signature verification device 11 or the like according to each embodiment is “connected” to multiple “electronic control units” 20 (hereinafter referred to as ECUs) constituting the electronic control system S.

The “electronic control unit” may be a physically independent electronic control unit or a virtualized electronic control unit implemented using a virtualization technique.

The term “connected” refers to a state in which data can be exchanged, and includes not only a case where different hardware is connected via a wired or wireless communication network but also a case where virtual machines implemented on the same hardware are virtually connected.

FIG. 2A illustrates a case where the signature verification device 11 or the like is provided inside the electronic control system S, and FIG. 2B illustrates a case where the signature verification device 11 or the like is provided outside the electronic control system S and inside the vehicle. That is, the signature verification device 11 or the like is “mounted” on the “moving object” together with the ECUs 20. In the cases of FIGS. 2A and 2B, the signature verification device 11 or the like is “connected” to the multiple ECUs 20 via an in-vehicle communication network such as a controller area network (CAN) or a local interconnect network (LIN). Alternatively, connection may be made by using any communication method, whether wired or wireless, such as Ethernet (registered trademark), Wi-Fi (registered trademark), and Bluetooth (registered trademark).

FIG. 2C illustrates a case where the signature verification device 11 or the like is provided outside the electronic control system S and outside the vehicle. That is, the ECUs 20 are “mounted” on the “moving object”, and the signature verification device 11 or the like is disposed outside the moving object. For example, the signature verification device 11 or the like is implemented by a server device or the like. In the case of FIG. 2C, the signature verification device 11 or the like is “connected” to the multiple ECUs 20 via a communication network called a wireless communication method such as IEEE802.11 (Wi-Fi (registered trademark)), IEEE802.16 (WiMAX (registered trademark)), wideband code division multiple access (W-CDMA), high speed packet access (HSPA), long term evolution (LTE), long term evolution advanced (LTE-A), 4G, or 5G. Alternatively, dedicated short range communication (DSRC) can be used. When the vehicle is parked in a parking lot or accommodated in a repair shop, a wired communication method can be used instead of the wireless communication method. For example, a local area network (LAN), the Internet, or a fixed telephone line can be used.

### (2) Configuration of Electronic Control System S

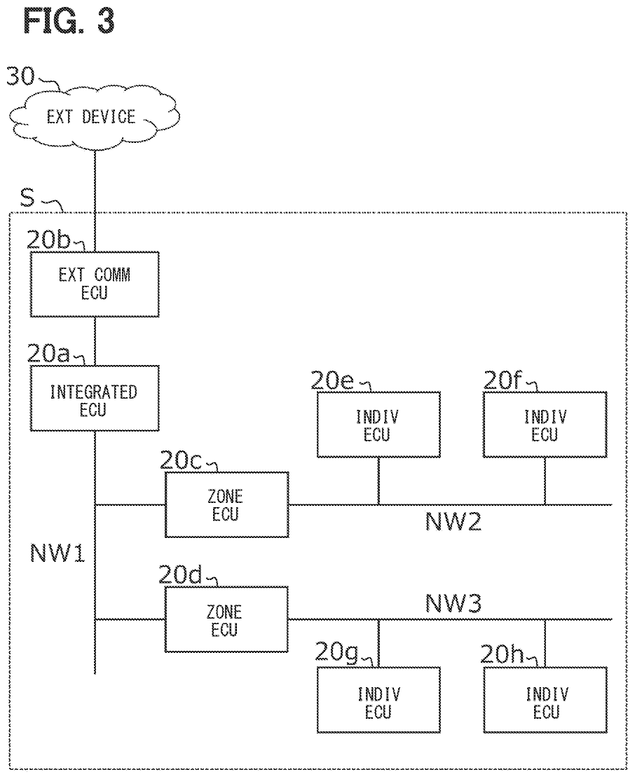

FIG. 3 is a diagram illustrating a configuration example of the electronic control system S. The electronic control system S includes the multiple ECUs 20 and in-vehicle networks (NW1 to NW3) connecting the ECUs 20. Although FIG. 3 illustrates eight ECUs (ECUs 20a to 20h), it is obvious that the electronic control system S may include any number of ECUs. In the following description, the ECU 20 and the ECUs 20 are described comprehensively for a single or multiple electronic control units, and the ECU 20a, ECU 20b, ECU 20c, . . . are described when individual electronic control units are specifically described.

In the case of FIG. 3, the ECUs 20 are connected to one another by the in-vehicle networks described with reference to FIGS. 2A and 2B, or other wired communication methods or wireless communication methods.

The electronic control system S illustrated in FIG. 3 includes the integrated ECU 20a, the external communication ECU 20b, the zone ECUs (20c, 20d), and the individual ECUs (20e to 20h).

The integrated ECU 20a is an ECU having a function of controlling the entire electronic control system S and a gateway function of mediating communication among the ECUs 20. The integrated ECU 20a may be referred to as a gateway ECU (G-ECU) or a mobility computer (MC). The integrated ECU 20a may be a relay device or a gateway device.

The external communication ECU 20b is an ECU including a communication unit that communicates with an external device provided outside the vehicle, for example, the external device 30 in each embodiment. A communication method used by the external communication ECU 20b is the wireless communication method or the wired communication method described with reference to FIG. 2C.

In order to implement multiple communication methods, multiple external communication ECUs 20b may be provided. Instead of providing the external communication ECU 20b, the integrated ECU 20a may have a function of the external communication ECU 20b.

Each of the zone ECUs (20c, 20d) is an ECU having a gateway function appropriately provided according to a function or a location where the individual ECU to be described later is arranged. For example, the zone ECU 20c is an ECU having a gateway function of mediating communication between the individual ECU 20e and the individual ECU 20f disposed on a front side of the vehicle and other ECUs 20, and the zone ECU 20d is an ECU having a gateway function of mediating communication between the individual ECU 20g and the individual ECU 20h disposed on a rear side of the vehicle and other ECUs 20. The zone ECUs (20c, 20d) may be referred to as domain computers (DCs). The individual ECU 20e and the individual ECU 20f are connected to the zone ECU 20c via the network 2 (NW2), and the individual ECU 20g and the individual ECU 20h are connected to the zone ECU 20d via the network 3 (NW3).

The individual ECUs (20e to 20h) can be implemented by ECUs having any function. Examples thereof include a drive system electronic control unit that controls an engine, a steering wheel, a brake, and the like, a vehicle body system electronic control unit that controls a meter, a power window, and the like, an information system electronic control unit such as a navigation device, and a safety control system electronic control unit that performs control for preventing a collision with an obstacle or a pedestrian. The ECUs may be classified into a master and a slave instead of being arranged in parallel.

In a first embodiment, a third embodiment, and a fourth embodiment, a case where the signature verification device 11, the signature verification device 13, and the encryption processing device 14 are provided in the integrated ECU 20a will be described as an example. In a second embodiment, a case where the signature verification device 12 is provided in the individual ECUs (20e to 20h) will be described as an example. However, the signature verification device 11 or the like may be provided in the external communication ECU 20b, the zone ECUs (20c to 20d), or the individual ECUs (20e to 20h). When provided in one of the individual ECUs (20e to 20h), it is desirable to use a dedicated ECU for implementing the signature verification device 11 or the like.

When the ECU 20, which is not the external communication ECU 20b, among the ECUs 20 constituting the electronic control system S, has a function of the signature verification device 11 or the like, a reception unit 101 of the signature verification device 11 or the like to be described later acquires a file from the outside of the electronic control system S via the external communication ECU 20b. In this case, the signature verification device 11 or the like is referred to as a UCM master in the automotive open system architecture (AUTOSAR) specification. The external communication ECU 20b is referred to as an over the air (OTA) client in the AUTOSAR specification. Each ECU 20 illustrated in FIG. 3 is referred to as an update and configuration management (UCM) subordinate in the AUTOSAR specification.

Hereinafter, the signature verification device 11 as an example of the first embodiment, the signature verification device 12 as an example of the second embodiment, the signature verification device 13 as an example of the third embodiment, and the encryption processing device 14 as an example of the fourth embodiment will be described.

### 2. First Embodiment

### (1) Difficulty of Related-Art

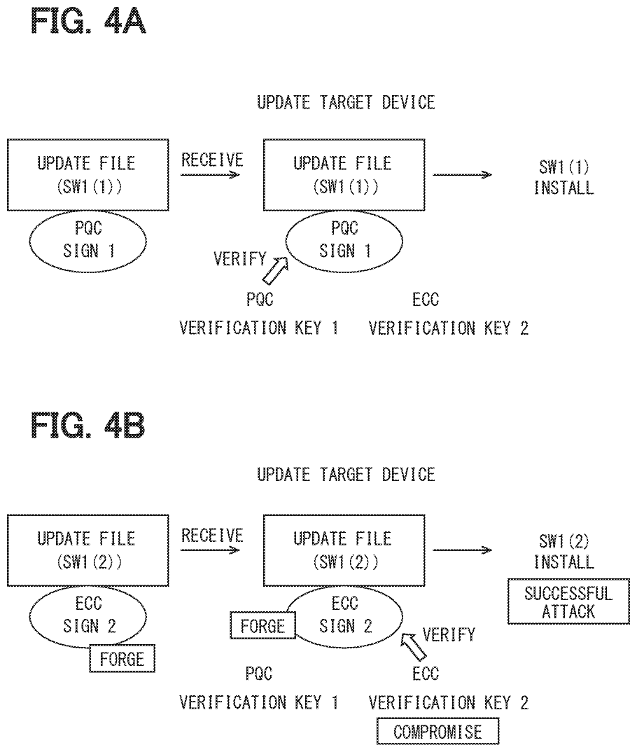

A related-art difficulty will be described with reference to FIGS. 4A and 4B.

FIG. 4A illustrates a state in which an update target device receives an update file (SW1(1)) for updating software from a distribution device and installs the software (SW1(1)).

The update target device has a verification key 1 that supports post-quantum cryptography (PQC) with a high security strength, and a verification key 2 that supports elliptic curve cryptography (ECC) with a medium security strength. In particular, in a case of a transitional period to next generation cryptography such as PQC, it is conceivable that a device that supports multiple types of cryptography will be required in order to support the next generation cryptography in case the cryptography is compromised while maintaining connectivity with existing cryptography. When the update target device receives the update file (SW1(1)) including a signature 1 that supports the PQC and the update software (SW1(1)), the update target device performs verification using the verification key 1, and installs the software (SW1(1)) if the verification is successful.

FIG. 4B illustrates a state in which the update target device receives the same software (SW1(2)) again from the distribution device and installs the software (SW1(2)).

When the update target device receives the update file (SW1(2)) including a signature 2 that supports the ECC and the update software (SW1(2)), the update target device performs verification using the verification key 2, and installs the currently received software (SW1(2)) so as to overwrite the currently installed software (SW1(1)) if the verification is successful.

When an algorithm of the ECC or the verification key 2 of the ECC is compromised at the time of receiving the update file (SW1(2)) from the distribution device, the signature 2 attached to the update file (SW1(2)) may be forged. In this case, even when the verification is performed using the compromised verification key 2, the verification is successful, and the software (SW1(2)) is installed. If the software (SW1(2)) has a vulnerability or is downgraded, the update target device is exposed to a cyberattack or other risks.

The software (SW1(1)) and the software (SW1(2)) do not need to be completely the same. For example, a function or the like may be added, a version may be different, or a modification may be made as described above. That is, the software may be handled as the same software in the update target device, such as being subjected to an overwrite operation in the update target device. The same applies to the second embodiment and the fourth embodiment in addition to the present embodiment.

The present embodiment is intended to eliminate such an update of unauthorized software.

### (2) Configuration of Signature Verification Device 11

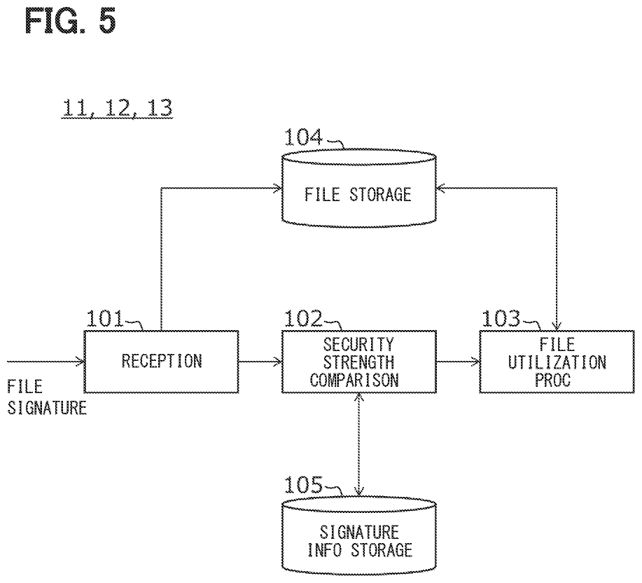

A configuration example of the signature verification device 11 according to the present embodiment will be described with reference to FIG. 5. The signature verification device 11 includes a reception unit 101, a security strength comparison unit 102, a file utilization processing execution unit 103, a file storage unit 104, and a signature information storage unit 105. In the present embodiment, the signature verification device 11 is provided in the integrated ECU 20a in FIG. 3. Update target devices are the zone ECUs (20c and 20d), the individual ECUs (20e to 20h), the external communication ECU 20b, and the integrated ECU 20a in FIG. 3.

The signature verification device 11 can be implemented by a general-purpose central processing unit (CPU), a volatile memory such as a RAM, a non-volatile memory such as a ROM, a flash memory, or a hard disk, various interfaces, and an internal bus connecting these. By executing software on the hardware, functions of the functional blocks illustrated in FIG. 5 can be implemented.

The signature verification device 11 is a device that receives a file that records “information” and a “signature generated based on the information” from the external device 30 and executes processing on the file. The same applies to the signature verification device 12 according to the second embodiment and the signature verification device 13 according to the third embodiment.

The “information” includes software or data. The software includes not only software that operates on an operating system (OS) but also middleware (for example, OS). The data includes moving images, still images, maps, sounds, and the like. The “signature generated based on the information” includes a signature directly generated based on all or a part of the information and a signature indirectly generated based on all or a part of the information, for example, a signature generated based on a hash value obtained from all or a part of the information.

In the present embodiment, the signature verification device 11 is an update control device that controls an update of software for an update target device, which is an update target of “software” that is “information”, among the multiple connected ECUs 20. Such an update control device may be implemented by the integrated ECU 20a that receives distribution of an update program provided from the external device 30 and manages the update target device in the electronic control system S, and is also referred to as over the air (OTA) reprogramming.

The “software” includes not only software that operates on an operating system (OS) but also middleware (for example, OS) that operates the electronic control unit itself.

The reception unit 101 receives an update file (corresponding to a “file”) and a signature attached to the update file from the external device 30 that is a distribution device, for example. Specifically, the update file (SW1(N)) and the signature are received. The received update file is output to the file storage unit 104. The file storage unit 104 may use a non-volatile or volatile recording medium. The file storage unit 104 is preferably provided in a secure area.

As illustrated in FIGS. 2A and 2B, when the signature verification device 11 is mounted on the moving object, the external communication ECU 20b receives an update file from a server device or the like provided outside the electronic control system S via wireless communication or wired communication, and the reception unit 101 of the signature verification device 11 receives the update file transmitted from the external communication ECU 20b via an in-vehicle network.

As illustrated in FIG. 2C, when the signature verification device 11 is implemented by a server device or the like outside the vehicle, the reception unit 101 of the signature verification device 11 receives, via wireless communication or wired communication, an update file generated by the server device or another device.

The update file includes an update file for updating software installed in an update target device. The update file may be an update file group including multiple update files for updating multiple pieces of software. The update file group may include update files used for multiple update target devices, respectively. Alternatively, the update file may be files obtained by dividing one update file into multiple pieces.

The update file may include information specifying an update target device installed with software to be updated and information indicating a data amount of each update file. The information may be stored in a header of the update file or may be stored in an update data portion of the update file.

The signature may include information indicating a size of the signature, a key used for the signature, and a signing method. Information indicating a security strength to be described later may be included. The information may be stored in a header of the signature.

The security strength comparison unit 102 compares a first security strength, which is a security strength of a signature currently received by the reception unit 101, with a second security strength, which is a security strength of a signature received together with a file previously received by the reception unit 101. Specifically, the security strength of the signature attached to the update file (SW1(N)) currently received by the reception unit 101 (corresponding to the “first security strength”) is compared with the security strength of the signature of the previously received update file (SW1(N−1)) (corresponding to the “second security strength”). The security strength of the previously received update file is used by reading signature information stored in the signature information storage unit 105.

A relationship between software (SW1(N−1)) and software (SW1(N)) is as described in the related-art difficulty of the present embodiment.

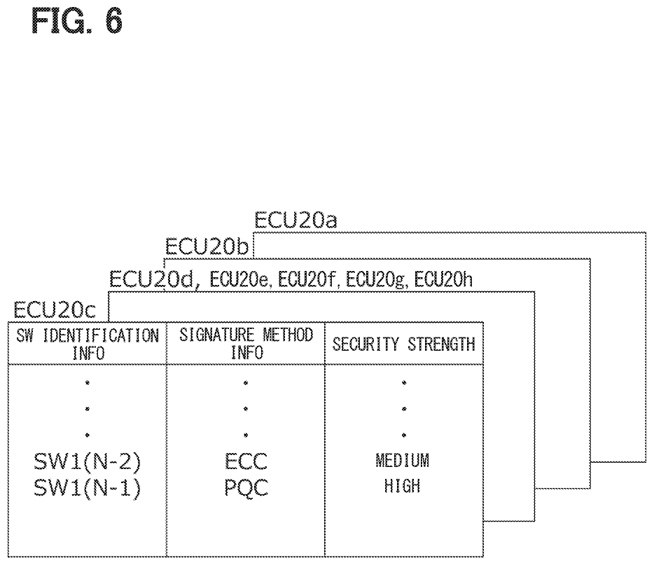

FIG. 6 is an example of a signature information table stored in the signature information storage unit 105.

The signature information table is provided for each update target device, and SW identification information, signature method information, and the security strength are recorded in each signature information table.

The SW identification information is information identifying software included in the received update file. In FIG. 6, SW1 is assigned as information indicating a type of software, and (N−1) and (N−2) are assigned as identifiers for distinguishing between software of the same type. N is the number of receptions, time information such as a time stamp, or information indicating a software version. When there are multiple types of software, for example, when there are four types SW1 to SW4, information identifying all types of software SW1 to SW4 may be recorded.

The signature method information is information indicating a signature method of the signature attached to the software. In FIG. 6, ECC and PQC are recorded as information indicating the signature method, and more detailed information may be recorded. For example, detailed examples of PQC include CRYSTAL-Dilithium, FALCON, and SPHINCS+, which are standard PQCs selected by the US National Institute of Standards and Technology in July 2022. In addition, information such as AES-128, AES-192, and AES-256 may be used.

The security strength is a security strength of the signature method. The security strength is determined based on an algorithm of the signature method and a length of a key used for the signature. In FIG. 6, the security strength is illustrated in three stages of high, medium, and low, and may be illustrated in more stages. Alternatively, the security strength may be indicated by a numerical value indicating a bit unit instead of the stage.

In FIG. 6, both the signature method information and the security strength are recorded, but either one may be recorded. When only the signature method information is recorded, the security strength can be obtained by separately preparing a table indicating a correspondence relationship between the signature method that may be usable and the security strength.

In FIG. 6, the signature information is recorded for all the previously received software, but in order to reduce a size of the signature information storage unit 105, the signature information may be recorded only for the software received most recently.

Returning to FIG. 5, the signature information storage unit 105 stores the signature information table. The signature information storage unit 105 may use a non-volatile or volatile recording medium. The signature information storage unit 105 is preferably provided in a secure area.

The file utilization processing execution unit 103 executes “processing for utilizing a file”. In the present embodiment, specifically, software included in the update file received by the reception unit 101 and an installation instruction instructing installation of the software are transmitted to the update target device.

When the update target device is the integrated ECU 20a, that is, the signature verification device 11 and the update target device are implemented by the same integrated ECU 20a, the software and the installation instruction do not need to be transmitted to the update target device, and thus the software is installed in the integrated ECU 20a that is the update target device. An embodiment in which the signature verification device 11 and the update target device are the same device will be described as in the second embodiment.

The “processing for utilizing a file” may be any processing necessary for utilizing the file, and may be processing of a previous stage or a subsequent stage in addition to processing utilizing the file itself.

When a comparison result of the security strength comparison unit 102 is that a security strength of a signature attached to the update file (SW1(N)) (corresponding to the “first security strength”) is equal to or higher than a security strength of a signature of the update file (SW1(N−1)) (corresponding to the “second security strength”), that is, a security strength of the former is higher than a security strength of the latter, or a security strength of the former is equal to a security strength of the latter, the file utilization processing execution unit 103 transmits an installation instruction of the software (SW1(N)) and the software (SW1(N)) to the update target device. That is, processing for installing the software (SW1(N)) is to be executed.

Then, the security strength comparison unit 102 outputs signature information on the signature attached to the update file (SW1(N)) to the signature information storage unit 105, and the signature information storage unit 105 stores the signature information.

On the other hand, when the comparison result of the security strength comparison unit 102 is that a security strength of the signature attached to the update file (SW1(N)) (corresponding to the “first security strength”) is lower than a security strength of the signature of the update file (SW1(N−1)) (corresponding to the “second security strength”), the file utilization processing execution unit 103 does not transmit the installation instruction of the software (SW1(N)) and the software (SW1(N)) to the update target device. That is, processing for installing the software (SW1(N)) is not to be executed.

The security strength comparison unit 102 does not output the signature information of the update file (SW1(N)) to the signature information storage unit 105.

In the present embodiment, when the security strength of the signature attached to the update file (SW1(N)) and the security strength of the signature of the update file (SW1(N−1)) are the same, the processing for utilizing the file is to be executed, and alternatively, the processing for utilizing the file may not to be executed in this case.

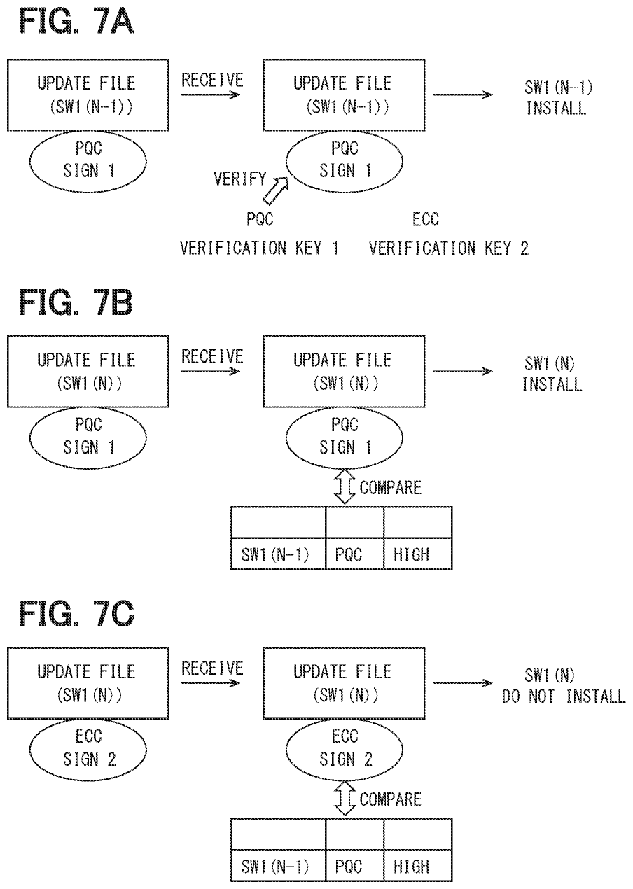

FIGS. 7A to 7C are specific examples of an operation of the signature verification device 11.

FIG. 7A illustrates previous processing.

The reception unit 101 received the update file (SW1(N−1)) and the signature 1 that supports the PQC. Then, the signature 1 was verified with the verification key 1, and when the verification was successful, the software (SW1(N−1)) was installed.

FIGS. 7B and 7C illustrate current processing.

The reception unit 101 receives the update file (SW1(N−1)) and the signature 1 that supports the PQC.

The security strength comparison unit 102 reads the security strength of the signature of the software (SW1(N−1) from the signature information table in the signature information storage unit 105, and compares a security strength of the signature 1 attached to the update file (SW1(N)) with a security strength of the signature 1 attached to the update file (SW1(N−1)). In a case of FIG. 7B, since the security strength of the signature 1 of the update file (SW1(N)) is “high”, and the security strength of the signature 1 of the update file (SW1(N−1)) is “high”, the security strength of the signature 1 of the update file (SW1(N)) is the same as the security strength of the signature 1 of the update file SW1(N−1)), that is, the security strength of the signature 1 of the update file (SW1(N)) is equal to or higher than the security strength of the signature 1 of the update file SW1(N−1)).

Therefore, the file utilization processing execution unit executes processing for installing the software (SW1(N)) included in the update file (SW1(N)).

In FIG. 7C, the reception unit 101 receives the update file (SW1(N)) and the signature 2 that supports the ECC.

The security strength comparison unit 102 reads the security strength of the signature of the software (SW1(N−1)) from the signature information table in the signature information storage unit 105, and compares a security strength of the signature 2 attached to the update file (SW1(N)) with a security strength of the signature 2 attached to the update file (SW1(N−1)). In a case of FIG. 7C, since the security strength of the signature 2 of the update file (SW1(N)) is “medium”, and the security strength of the signature 2 of the update file (SW1(N−1)) is “high”, the security strength of the signature 2 of the update file (SW1(N)) is lower than the security strength of the signature 2 of the update file (SW1(N−1)).

Therefore, the file utilization processing execution unit does not execute the processing for installing the software (SW1(N)) included in the update file (SW1(N)).

### (3) Operation of Signature Verification Device 11

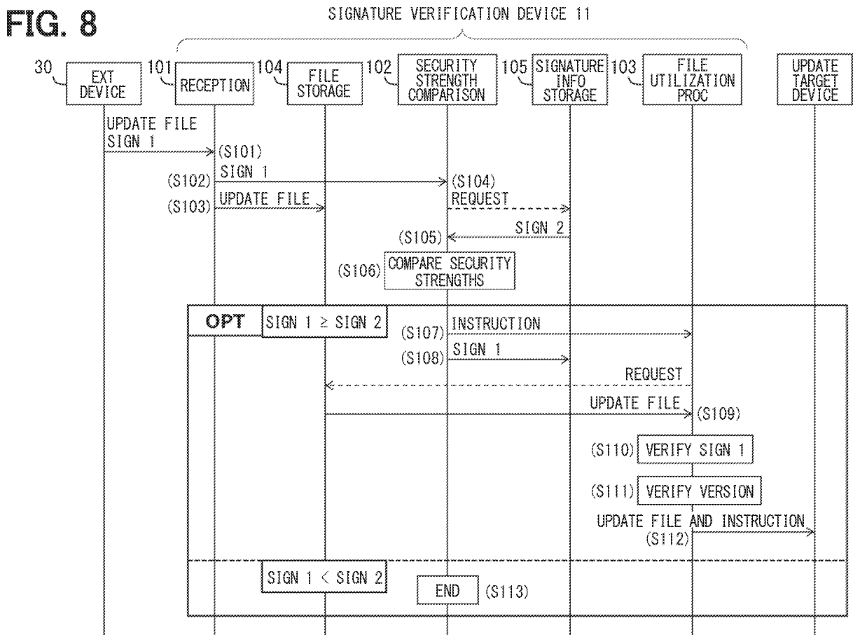

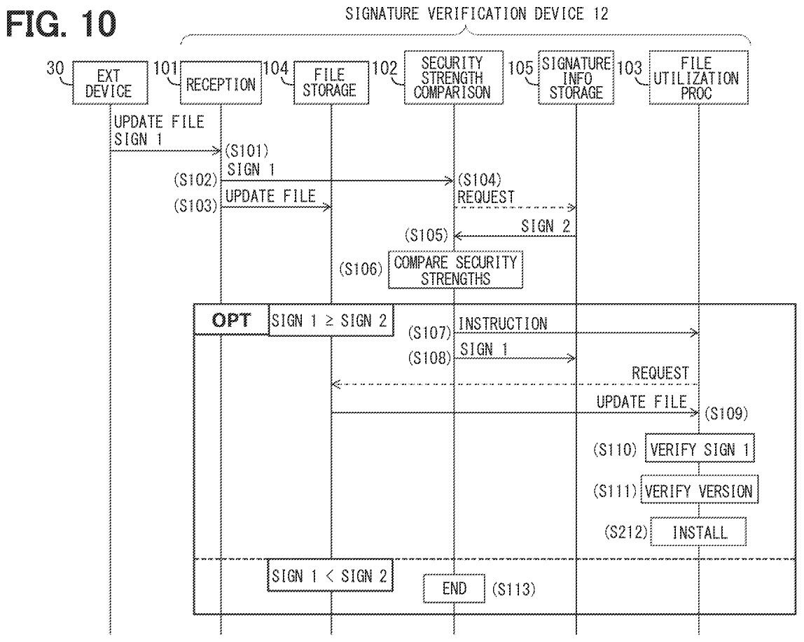

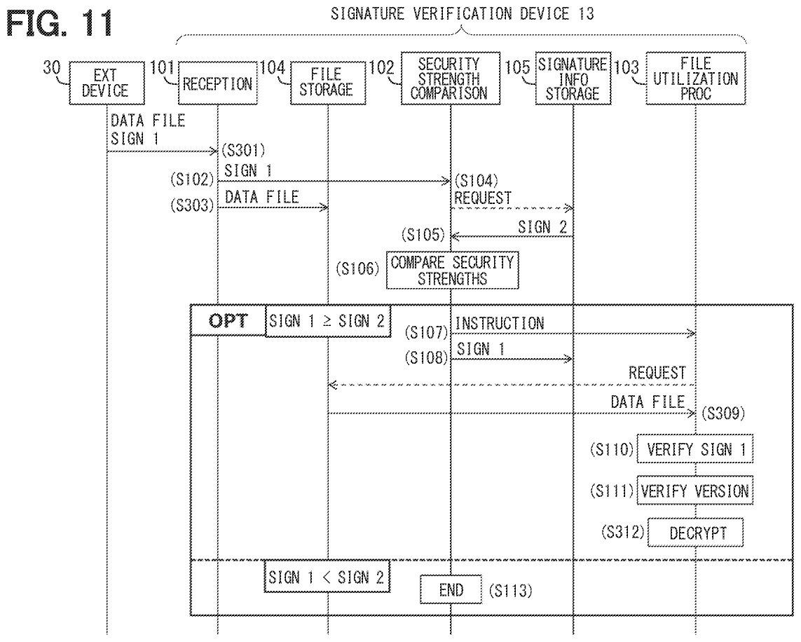

An operation of the signature verification device 11 will be described with reference to FIG. 8. The operation illustrated in FIG. 8 not only illustrates a signature verification method executed by the signature verification device 11, but also illustrates a processing procedure of a signature verification program executable by the signature verification device 11. An order of the processing described above is not limited to that illustrated in FIG. 8. That is, unless there is a restriction such as a relationship in which a step uses a result of the previous step, the order may be reversed. The same applies to FIGS. 10 and 11 to be described later.

The reception unit 101 of the signature verification device 11 receives, from the external device 30, an update file that records software and the signature 1 generated based on the software (S101).

The reception unit 101 outputs the signature 1 to the security strength comparison unit 102 (S102), and stores the update file in the file storage unit 104 (S103).

The security strength comparison unit 102 receives the signature 1 from the reception unit 101 (S104).

Next, the security strength comparison unit 102 outputs a read request to the signature information storage unit 105, and reads, from the signature information storage unit 105, the signature 2 received together with a previously received update file (S105).

Then, the security strength comparison unit 102 compares a security strength of the signature 1 (corresponding to the “first security strength”) with a security strength of the signature 2 (corresponding to the “second security strength”) (S106).

The security strength comparison unit 102 may read the security strength of the signature 2 (corresponding to the “second security strength”) instead of reading the signature 2 from the signature information storage unit 105.

When the security strength of the signature 1 is equal to or higher than the security strength of the signature 2, the security strength comparison unit 102 instructs the file utilization processing execution unit 103 to execute file utilization processing (S107).

The security strength comparison unit 102 outputs signature information on the signature 1 to the signature information storage unit 105, and the signature information storage unit 105 stores the signature information on the signature 1 (S108).

The file utilization processing execution unit 103 executes processing for utilizing a file. In the present embodiment, specifically, the update file is read from the file storage unit 104 (S109), the signature 1 is verified (S110), and version verification or rollback verification is further performed (S111). The version verification refers to, for example, confirming that a version of updated software is higher than a version of pre-updated software. The rollback verification refers to confirming that the software is returned to software of a previous version due to a defect of the software or the like, for example, refers to confirming that a version of updated software is older than a version of pre-updated software. The version verification or the rollback verification is as desired.

When the verification of the signature 1, the version verification, and the like are successful, the update file and an installation instruction are transmitted to the update target device (S112).

When the security strength of the signature 1 is lower than the security strength of the signature 2, the security strength comparison unit 102 ends the series of processing (S113). As a result, the file utilization processing execution unit 103 does not execute the processing for utilizing the file.

As described above, according to the signature verification device 11 of the present embodiment, since whether to execute processing for utilizing a file is determined by comparing a security strength of a received signature with a security strength of a previously received signature, utilization of a potentially fraudulent file can be restricted even when a key is compromised or an algorithm is compromised.

According to the signature verification device 11 of the present embodiment, an update of unauthorized software can prevented by determining whether to update software of the ECU 20 that is an update target device. For example, installation of vulnerable software and downgrade attacks can be prevented.

### (5) First Modification

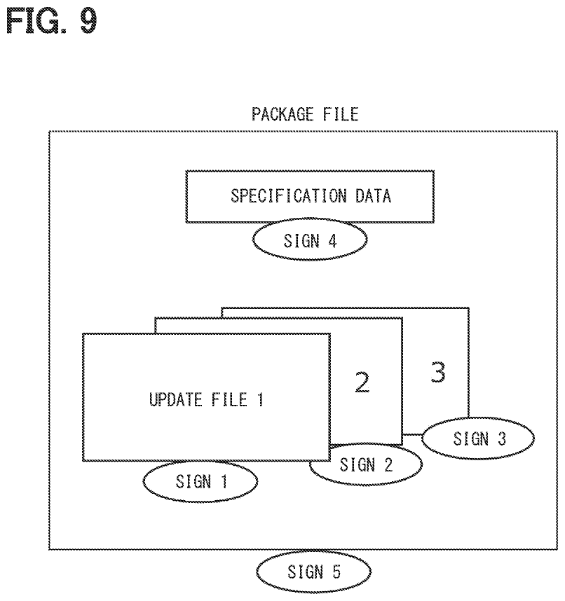

In the present embodiment, a signature is attached to each file, and a security strength of the file is compared with that of a previously received file. However, files may have an inclusion relationship, that is, a relationship that one file is included in another file. For example, as illustrated in FIG. 9, one package file includes update files for multiple pieces of software and specification data, the update files have signatures (signature 1, signature 2, signature 3) generated based on update files 1 to 3, the specification data has a signature (signature 4) generated based on the specification data, and the package file has a signature (signature 5) generated based on the package file.

In this case, the security strength comparison unit 102 compares a security strength of the signature with a security strength of a signature attached to the corresponding update file or data previously received. Then, when a security strength of at least one signature among the signatures is equal to or higher than a security strength of a signature attached to the corresponding file or data previously received, the file utilization processing execution unit 103 executes processing for utilizing the package file.

For example, in a case of FIG. 9, when at least one of security strengths of the signatures (signature 1, signature 2, and signature 3) generated based on the update files 1 to 3, the signature (signature 4) generated based on the specification data (corresponding to an “individual signature”), and the signature (signature 5) generated based on the package file (corresponding to an “entire signature”) is equal to or higher than a security strength of a corresponding signature attached to a package file, multiple update files included therein, or specification data previously received, the file utilization processing execution unit 103 executes processing for installing all the update files.

When an attacker attempts to update software in an unauthorized manner, it is necessary to forge all of the signatures 1 to 5. However, if even one signature is difficult to forge, all the signatures can be considered to be protected at a security level of the signature that is difficult to forge. According to the present modification, it is not necessary to verify all the signatures, and for example, if a signature verified first satisfies a condition, installation processing can be started, a load of the hardware can be lightened, and the installation processing can be promptly started.

The present modification can also be applied to the second to fourth embodiments.

### (6) Second Modification

When software has versions, a version of software included in a currently received file is usually higher than a version of the software included in a previously received file. That is, a function and attack resistance of the software become higher by repeatedly upgrading the version. For example, in FIGS. 7A to 7C, a version of the software (SW1(N)) included in the update file (SW1(N)) is higher than a version of the software (SW1(N−1)) included in the update file (SW1(N−1)).

However, when software of the latest version is downloaded and installed, an operation failure may occur due to hardware compatibility or hardware performance. A difficulty such as a bug may occur in the software of the latest version itself. In such a case, it is necessary to download software of a lower version in order to restore the software to the previous version.

Even in such a case, as in the present embodiment, when the comparison result of the security strength comparison unit 102 is that a security strength of a signature attached to the update file (SW1(N)) is equal to or higher than a security strength of a signature attached to the update file (SW1(N−1)), the file utilization processing execution unit 103 executes processing for installing software. When the comparison result of the security strength comparison unit 102 is that a security strength of the signature attached to the update file (SW1(N)) is lower than a security strength of the signature attached to the update file (SW1(N−1)), the file utilization processing execution unit 103 does not execute the processing for installing the software.

That is, in a case where the software is downgraded and installed, even if the same signature as a signature attached to previously downloaded software of the same lower version is attached this time, when software of a higher version is installed in the meantime, if a security strength of a signature attached to the software of the higher version is higher than a security strength of the signature attached to the software of the lower version, a signature equal to or higher than the security strength of the signature attached to the software of the higher version must be attached to the currently downloaded software of the lower version.

For example, when a security strength of a signature attached to the currently downloaded software of the lower version is lower than the security strength of the signature attached to the previously downloaded software of the higher version, the file utilization processing execution unit 103 may interrupt the processing for installing and transmit a request to the external device 30 to attach, via resending, a signature having a security strength equal to or higher than the security strength of the signature attached to the software of the higher version.

According to the present modification, whether to execute processing for utilizing a file is determined using a security strength of a signature even when software is downgraded. Therefore, utilization of a potentially fraudulent file can be restricted even when software of the same version has been previously downloaded, or even when a key is compromised or an algorithm is compromised subsequently.

The present modification can also be applied to the second to fourth embodiments.

### 3. Second Embodiment

### (1) Configuration of Signature Verification Device 12

In the signature verification device 11 according to the first embodiment, the signature verification device 11 and the update target device are provided in different devices. The signature verification device 12 according to the present embodiment is an example in which the signature verification device 12 is provided in the same device as an update target device. For example, in FIG. 3, the signature verification device 12 is provided in the individual ECU 20e, and the update target device is also provided in the individual ECU 20e. As described in the first embodiment, a case where signature verification device 11 is provided in integrated ECU 20a and the update target device is also provided in integrated ECU 20a also corresponds to the present embodiment.

The signature verification device 12 according to the present embodiment has the same configuration as the signature verification device 11 in FIG. 5 except for a part of an operation of the file utilization processing execution unit 103, and description of FIG. 5 and the first embodiment corresponding thereto will be cited. In addition, since at least FIG. 6 (any one signature information table) and FIGS. 7A to 7C are also diagrams illustrating the present embodiment, description of the first embodiment corresponding thereto will be cited. Hereinafter, only portions different from those according to the first embodiment will be described.

The signature verification device 12 according to the present embodiment is an update control device that controls an update of “software” that is “information” for the ECU 20 that implements the signature verification device 12. Such an update control device may be implemented by an update target device itself that receives distribution of an update program provided from a diagnosis device connected in a wired manner and has an update control function, and is also called wired reprogramming.

The file utilization processing execution unit 103 executes the “processing for utilizing a file” as in the first embodiment. In the present embodiment, specifically, software is installed in the ECU 20e that is an update target device and also serves as the signature verification device 12.

### (2) Operation of Signature Verification Device 12

An operation of the signature verification device 12 will be described with reference to FIG. 10. Hereinafter, only portions different from those in FIG. 8 illustrating the operation of the signature verification device 11 according to the first embodiment will be described, and description of the same portions as in FIG. 8 and the first embodiment corresponding thereto will be cited.

The file utilization processing execution unit 103 executes processing for utilizing a file. In the present embodiment, specifically, the update file is read from the file storage unit 104 (S109), the signature 1 is verified (S110), and version verification or rollback verification is performed (S111).

When the verification of the signature 1, the version verification, and the like are successful, software is installed in the ECU 20e that is an update target device and also serves as the signature verification device 12 (S212).

As described above, according to the signature verification device 12 of the present embodiment, since whether to execute processing for utilizing a file is determined by comparing a security strength of a received signature with a security strength of a previously received signature, utilization of a potentially fraudulent file can be restricted even when a key is compromised or an algorithm is compromised.

According to the signature verification device 12 of the present embodiment, an update of unauthorized software can prevented by determining whether to update software of a subject device that is an update target device. For example, installation of vulnerable software and downgrade attacks can be prevented.

### 4. Third Embodiment

### (1) Configuration of Signature Verification Device 13

The signature verification device 11 and the signature verification device 12 according to the first and second embodiments are update control devices that control an update of software for an update target device, which is an update target of “software” that is “information”, among the multiple connected ECUs 20.

The signature verification device 13 according to the present embodiment is a data utilization control device that controls utilization of “data” that is “information”. That is, the present embodiment is different from the first and second embodiments in that information included in a file is not software but data.

The “data” includes moving images, still images, maps, sounds, and the like, and a format of the data is as desired.

The signature verification device 13 according to the present embodiment has the same configuration as the signature verification device 11 in FIG. 5 except for a part of operations of the reception unit 101 and the file utilization processing execution unit 103, and description of FIG. 5 and the first embodiment corresponding thereto will be cited. In addition, since at least FIGS. 6 and 7A to 7C are also diagrams illustrating the present embodiment, description of the first embodiment corresponding thereto will be cited. The software is appropriately read as data.

The reception unit 101 receives a data file (corresponding to a “file”) and a signature attached to the data file from the external device 30 that is a distribution device, for example. The received data file is output to the file storage unit 104.

The file utilization processing execution unit 103 executes the “processing for utilizing a file” as in the first embodiment. In the present embodiment, specifically, data is decrypted or stored, or data is downloaded.

When the processing for utilizing the file is data decryption, the file utilization processing execution unit 103 reads the data file from the file storage unit 104 and decrypts the encoded data.

When the processing for utilizing the file is data storage, the file utilization processing execution unit 103 reads the data file from the file storage unit 104 and stores the data file in a predetermined recording device. The predetermined recording device may be provided in the ECU 20 in which the signature verification device 13 is mounted or may be provided in other ECUs 20. The former case corresponds to the processing according to the second embodiment, and the latter case corresponds to the processing according to the first embodiment.

When the processing for utilizing the file is data downloading, the file utilization processing execution unit 103 requests the external device 30 to transmit data from a transmission unit (not illustrated), and the reception unit 101 receives the data file.

### (2) Operation of Signature Verification Device 13

An operation of the signature verification device 13 will be described with reference to FIG. 11. Hereinafter, only portions different from those in FIG. 8 illustrating the operation of the signature verification device 11 according to the first embodiment will be described, and description of the same portions as in FIG. 8 and the first embodiment corresponding thereto will be cited.

The reception unit 101 of the signature verification device 13 receives, from the external device 30, a data file that records data and the signature 1 generated based on the data (S301).

The reception unit 101 outputs the signature 1 to the security strength comparison unit 102 (S102), and stores the data file in the file storage unit 104 (S303).

The file utilization processing execution unit 103 executes processing for utilizing a file. In the present embodiment, specifically, the data file is read from the file storage unit 104 (S309), the signature 1 is verified (S110), and version verification or rollback verification is performed (S111).

When the verification of the signature 1, the version verification, and the like are successful, the file utilization processing execution unit 103 decrypts the data file and displays the decrypted data file (S312).

As described above, according to the signature verification device 13 of the present embodiment, since whether to execute processing for utilizing a data file is determined by comparing a security strength of a received signature with a security strength of a previously received signature even when the data file is downloaded from the external device 30, utilization of a potentially fraudulent data file can be restricted even when a key is compromised or an algorithm is compromised.

### 5. Fourth Embodiment

### (1) Configuration of Encryption Processing Device 14

The signature verification device 11, the signature verification device 12, and the signature verification device 13 according to the first to third embodiments are devices that verify a signature attached to a file.

The encryption processing device 14 according to the present embodiment is an encryption processing device that receives a file that records encrypted information from the external device 30 and executes processing on the file.

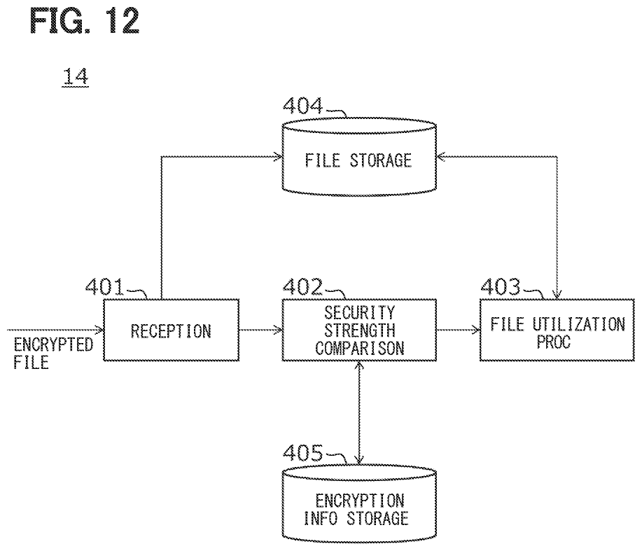

A configuration example of the encryption processing device 14 according to the present embodiment will be described with reference to FIG. 12. The encryption processing device 14 includes a reception unit 401, a security strength comparison unit 402, a file utilization processing execution unit 403, a file storage unit 404, and an encryption information storage unit 405. In the present embodiment, the encryption processing device 14 is provided in the integrated ECU 20a in FIG. 3.

The reception unit 401 receives a file that records encrypted information (hereinafter referred to as an encrypted file) from the external device 30 that is a distribution device, for example. The encrypted information is, for example, encrypted software or encrypted data.

The encrypted file may include a key used for encryption and information indicating an encryption method. Information indicating a security strength may also be included. The information may be stored in a header of the encrypted file.

The security strength comparison unit 402 compares a first security strength, which is a security strength of encryption used in an encrypted file currently received by the reception unit 401, with a second security strength, which is a security strength of encryption used in an encrypted file previously received by the reception unit 401. The security strength of the encryption used in the encrypted file previously received is used by reading encryption information stored in the encryption information storage unit 405.

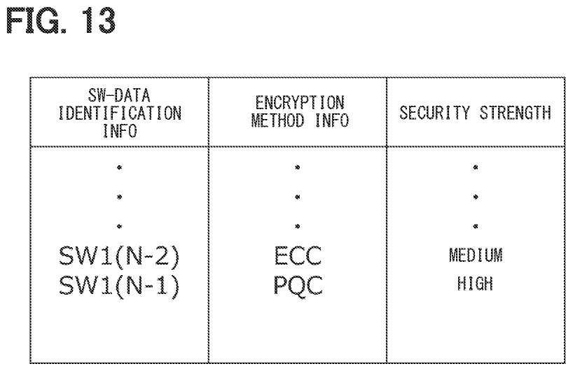

FIG. 13 is an example of an encryption information table stored in the encryption information storage unit 405.

Different from the first embodiment, at least one encryption information table may be provided. SW-data identification information, encryption method information, and the security strength are recorded in the encryption information table.

The SW-data identification information is information identifying software or data included in the received encrypted file. In FIG. 13, SW1 is assigned as information indicating a type of software, and (N−1) and (N−2) are assigned as identifiers for distinguishing between software of the same type. Others are the same as those according to the embodiments illustrated in FIG. 6.

The encryption method information is information indicating an encryption method of the encrypted file. In FIG. 13, ECC and PQC are recorded as information indicating the encryption method, and more detailed information may be recorded.

The security strength is a security strength of the encryption method. The security strength is determined based on an algorithm of the encryption method and a length of a key used for the encryption. In FIG. 13, the security strength is illustrated in three stages of high, medium, and low, and may be illustrated in more stages. Alternatively, the security strength may be indicated by a numerical value indicating a bit unit instead of the stage.

Returning to FIG. 12, the encryption information storage unit 405 stores the encryption information table. The encryption information storage unit 405 may use a non-volatile or volatile recording medium. The encryption information storage unit 405 is preferably provided in a secure area.

The file utilization processing execution unit 403 executes “processing for utilizing a file”. In the present embodiment, specifically, information recorded in the encrypted file is decrypted or stored, or information is downloaded. When the information is software, the encrypted file is transmitted to an update target device, or the software is installed.

Since an operation of the file utilization processing execution unit 403 is the same as that according to the first embodiment, description of the first embodiment will be cited. At this time, a signature is read as encryption, a verification key is read as a decryption key, and verification is read as decryption.

As described above, according to the encryption processing device 14 of the present embodiment, since whether to execute processing for utilizing a file is determined by comparing a security strength of encryption used to encrypt a received file and a security strength of encryption used to encrypt a previously received file, utilization of a potentially fraudulent encrypted file can be restricted even when a key is compromised or an algorithm is compromised.

Features of the signature verification device, the encryption processing device, and the like in the embodiments of the present disclosure have been described above.

Since terms used in the embodiments are examples, the terms may be replaced with synonymous terms or terms including synonymous functions.

The block diagrams used for the description of the embodiments are obtained by classifying and organizing the configurations of the devices for each function. The blocks representing the respective functions may be implemented by any combination of hardware or software. Since the blocks represent the functions, such a block diagram may also be understood as disclosures of a method and a program for implementing the method.

An order of functional blocks that can be understood as processes, flows, and methods described in the embodiments may be changed as long as there are no restrictions such as a relation in which results of preceding processes are used in one other process.

The terms such as first, second, to N-th (where N is an integer) used in each embodiment and in the disclosure are used to distinguish two or more configurations and methods of the same kind and are not intended to limit the order or superiority.

Further, examples of the device described in the present disclosure include the following. Examples of a form of a component include a semiconductor element, an electronic circuit, a module, and a microcomputer. Examples of a form of a semi-finished product include an electric control unit (ECU) and a system board. Examples of a form of a finished product include a cellular phone, a smartphone, a tablet computer, a personal computer (PC), a workstation, and a server. In addition, the devices may include a device having a communication function or the like, and examples thereof include a video camera, a still camera, and a car navigation system.

Necessary functions such as an antenna or a communication interface may be added to each device.

The disclosure can be implemented not only by dedicated hardware having the configurations and functions described in the embodiments, but also by a combination of a program or program code, which are recorded on a recording medium such as a memory or a hard disk and is used for implementing the disclosure, and general-purpose hardware that has a dedicated or general-purpose CPU that can execute the program or the program code, a memory, and the like.

A program stored in a non-transitory tangible storage medium (for example, an external storage device (a hard disk, a USB memory, and a CD/BD) of dedicated or general-purpose hardware, or an internal storage device (a RAM, a ROM, and the like)) may also be provided to dedicated or general-purpose hardware via the recording medium or from a server via a communication line without using the recording medium. Thereby, the latest functions can be provided at all times through program upgrade.

The present disclosure has been mainly described as a signature verification device and cryptographic processing device for an in-vehicle electronic control device installed in a vehicle. Alternatively, the device may be applied to general mobile bodies such as a motorcycle, a ship, a train, and an aircraft. Further, the present disclosure is applicable not only to mobile objects but also to general products including microcomputers.

What is claimed is:

1. A signature verification device that receives, from an external device, a file that records information and a signature generated based on the information, and executes processing on the file, the signature verification device comprising:
a reception unit configured to receive the file and the signature;
a security strength comparison unit configured to compare a first security strength, which is a security strength of the signature, with a second security strength, which is a security strength of a signature received together with a previously received file; and
a file utilization processing execution unit configured to execute processing for utilizing the file,
wherein
the file utilization processing execution unit is configured to
execute the processing for utilizing the file when the first security strength is higher than the second security strength, and
not execute the processing for utilizing the file when the first security strength is lower than the second security strength.

2. The signature verification device according to claim 1, wherein
the file utilization processing execution unit executes the processing for utilizing the file when the first security strength is equal to or higher than the second security strength.

3. The signature verification device according to claim 2, wherein
the signature verification device is an update control device that controls an update of software, that is the information, for an update target device that is an update target of the software, among a plurality of connected electronic control units, and
the file utilization processing execution unit transmits the file to the update target device as the processing for utilizing the file.

4. The signature verification device according to claim 2, wherein
the signature verification device is an update control device that controls an update of software, that is the information, for an electronic control unit that implements the signature verification device, and
the file utilization processing execution unit installs the software as the processing for utilizing the file.

5. The signature verification device according to claim 1, wherein
the signature verification device is a data utilization control device that controls utilization of data that is the information, and
the file utilization processing execution unit decrypts or stores the data or downloads the data as the processing for utilizing the file.

6. The signature verification device according to claim 3, wherein
the file includes a plurality of pieces of software,
the signature includes a plurality of individual signatures generated respectively based on the plurality of pieces of software and an entire signature generated based on the file, and
the file utilization processing execution unit executes the processing for utilizing the file when at least one of first security strengths of the plurality of individual signatures and the entire signature is higher than the second security strength of a corresponding individual signature or entire signature.

7. The signature verification device according to claim 3, wherein
a version of the software included in the received file is lower than a version of software included in the previously received file.

8. The signature verification device according to claim 2, wherein
the security strength of the signature is determined based on an algorithm of a signature method of the signature and a length of a key used for the signature.

9. The signature verification device according to claim 1, wherein
the signature verification device is mounted on a moving object.

10. The signature verification device according to claim 3, wherein
the signature verification device is mounted on a moving object together with the electronic control unit.

11. The signature verification device according to claim 3, wherein
the electronic control unit is mounted on a moving object, and
the signature verification device is disposed outside the moving object.

12. A signature verification method executed by a signature verification device that receives, from an external device, a file that records information and a signature generated based on the information, and executes processing on the file, the signature verification method comprising:
receiving the file and the signature;
comparing a first security strength, which is a security strength of the signature, with a second security strength, which is a security strength of a signature received together with a previously received file;
executing processing for utilizing the file when the first security strength is higher than the second security strength; and
not executing the processing for utilizing the file when the first security strength is lower than the second security strength.

13. A non-transitory computer readable storage medium storing a signature verification program executable by a signature verification device that receives, from an external device, a file that records information and a signature generated based on the information, and executes processing on the file, the signature verification program comprising:
receiving the file and the signature;
comparing a first security strength, which is a security strength of the signature, with a second security strength, which is a security strength of a signature received together with a previously received file;
executing processing for utilizing the file when the first security strength is higher than the second security strength; and
not executing the processing for utilizing the file when the first security strength is lower than the second security strength.

14. An encryption processing device that receives a file that records encrypted information from an external device, and executes processing on the file, the encryption processing device comprising:
a reception unit configured to receive the file;
a security strength comparison unit configured to compare a first security strength, which is a security strength of encryption used to encrypt the information, with a second security strength, which is a security strength of encryption used to encrypt information included in a previously received file; and
a file utilization processing execution unit configured to execute processing for utilizing the file,
wherein
the file utilization processing execution unit is configured to
execute the processing for utilizing the file when the first security strength is higher than the second security strength, and
not execute the processing for utilizing the file when the first security strength is lower than the second security strength.

15. The encryption processing device according to claim 14, wherein
the file utilization processing execution unit decrypts or stores the information or downloads the information as the processing for utilizing the file.
